(19) United States
(12) Patent Application Publication
(10) Pub. No.: US 2010/0130268 A1
(43) Pub. Date: May 27, 2010

(54) BATTERY COVER LATCH MECHANISM AND PORTABLE ELECTRONIC DEVICE USING SAME

(75) Inventors: LUCAS HUANG, Shenzhen City (CN); LEE-HAN NG, Shenzhen City (CN); CHIEN-CHUN HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/495,885

(22) Filed: Jul. 1, 2009

(30) Foreign Application Priority Data
Nov. 26, 2008 (CN) 200810305761.2

(51) Int. Cl. H04M 1/00; H01M 2/10

(52) U.S. Cl. 455/575.1; 429/100

(57) ABSTRACT

The battery cover latch mechanism includes a housing, a battery cover comprising a clasp positioned thereon, a button assembled on the housing, a latching part slidably assembled on the housing; and resisting the button, and a resilient member assembled on the latching part, and resisting the housing. The clasp latches to the latching part to assemble the battery cover on the housing, when the button is pressed, the latching part compresses the resilient member, and the latching part is detached from the clasp by the button. The invention also discloses a portable electronic device using the battery cover latch mechanism.

### BACKGROUND

1. Technical Field

The present disclosure relates to battery cover latch mechanisms used in portable electronic devices.

2. Description of Related Art

Portable electronic devices usually include latch mechanisms to latch battery covers to housings. The latch mechanisms must allow frequent installation and removal of batteries.

A typical latch mechanism includes a pair of hooks at one end of the battery cover and a locking pin protruding from the other end of the battery cover. The housing defines a pair of grooves and a locking hole. In assembly, the hooks are inserted into the grooves. The battery cover is pressed down to the housing until the locking pin is inserted into the locking hole. However, during disassembly, a large force is needed to remove the battery cover from the housing. It is difficult to install or remove the battery cover.

Therefore, there is a room for improvement within the art.

### BRIEF DESCRIPTION OF THE DRAWINGS

Many aspects of a battery cover latch mechanism and a portable electronic device using the battery cover latch mechanism can be better understood with reference to the following drawings. The components in the drawings are not necessarily to scale, the emphasis instead being placed upon clearly illustrating the principles of the present battery cover latch mechanism and a portable electronic device using the battery cover latch mechanism. Moreover, in the drawings, like reference numerals designate corresponding parts throughout the several views.

FIG. 1 is a partial and exploded view of a battery cover latch mechanism according to an exemplary embodiment.

FIG. 2 is similar to FIG. 1, but viewed from anther angle.

FIG. 3 is a perspective view of a latching part in FIG. 1.

FIG. 4 is a partial and assembled perspective view of the battery cover latch mechanism.

FIG. 5 is an assembled perspective view of the battery cover latch mechanism.

FIG. 6 is a cross-sectional view taken along line VI-VI of FIG. 5.

FIG. 7 is a cross-sectional view taken along line VI-VI of FIG. 5, showing the battery cover latch mechanism in an unlocked condition.

### DETAILED DESCRIPTION OF THE EMBODIMENTS

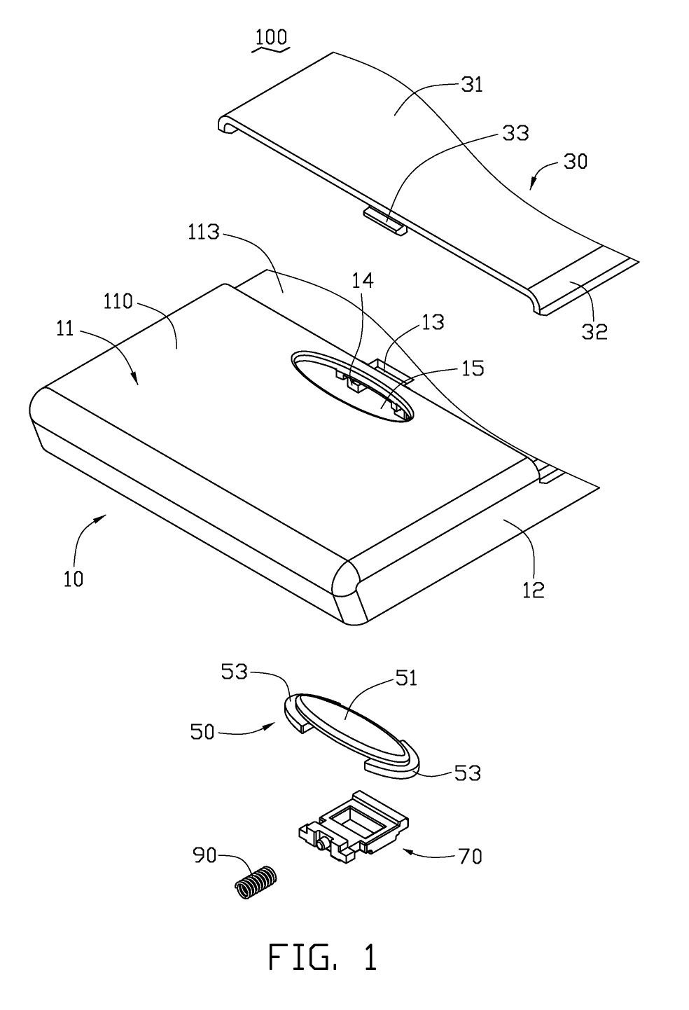

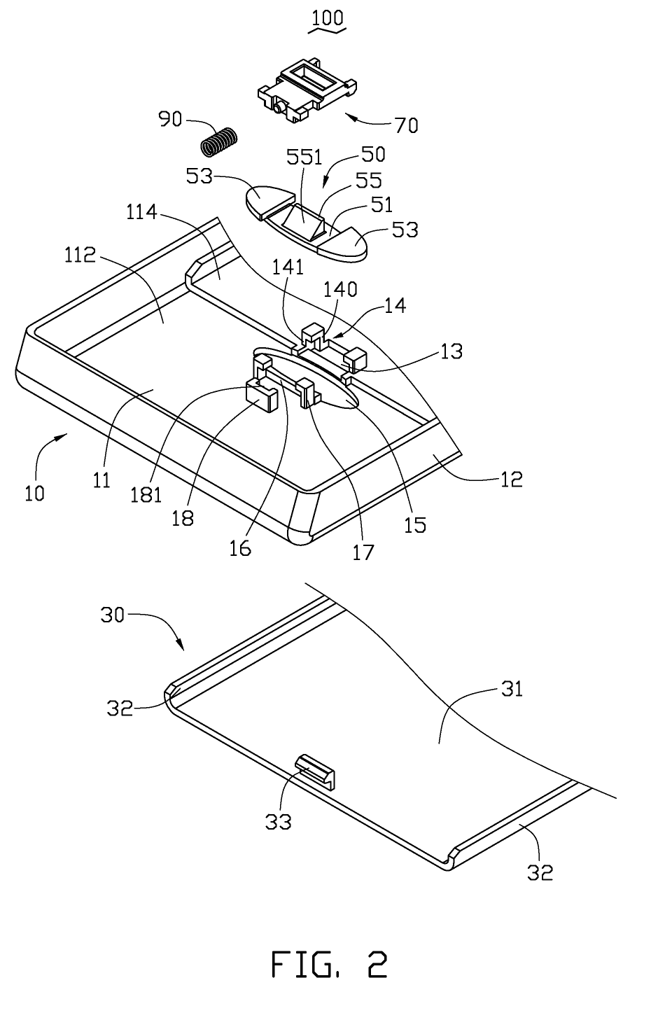

FIG. 1 and FIG. 2 show a portable electronic device using a battery cover latch mechanism 100. The battery cover latch mechanism 100 includes a housing 10, a battery cover 30, a button 50, a latching part 70, and a resilient member 90.

The housing 10 includes a main body 11 and four peripheral walls 12 bent away from the main body 11. The main body 11 includes a first wall 110, a second wall 112 opposite to the first wall 110, two supporting portions 14, a baffle plate 16, two resisting posts 17, and a resisting plate 18. The first wall 110 defines a recessed portion 113 for matching with the battery cover 30. Accordingly, the second wall 112 defines a flange portion 114 positioned thereon. The flange portion 114 defines a latching hole 13. The supporting portions 14 are symmetrically positioned at two sides of the latching hole 13. Each of the supporting portions 14 includes a main portion 140 and a plate body 141. Each main portion 140 is L-shaped. One end of the main portion 140 is secured on the flange portion 114. Each plate body 141 connects to the main portion 140. The supporting portions 14 are configured for receiving and supporting the latching part 70. The second wall 112 defines a through hole 15 adjacent to the latching hole 13. The through hole 15 is configured for receiving the button 50. The baffle plate 16 is positioned on the second wall 112, adjacent to the through hole 15, and located opposite to the supporting portions 14. Each of the resisting posts 17 is L-shaped and positioned on the second wall 112 and leaning against one side of the baffle plate 16 away from the latching hole 13. The resisting posts 17 respectively align with the supporting portions 14 and are configured for resisting the latching part 70. The resisting plate 18 is positioned on the second wall 112 and faces a side of the resisting posts 17 away form the latching hole 13. The resisting plate 18 defines a recessed groove 181 facing the baffle plate 16 and configured for receiving the resilient member 90.

The battery cover 30 includes a main cover 31, three sidewalls 32 bent from three edges of the main cover 31, and a clasp 33 positioned near a free end of the main cover 31. The sidewalls 32 are matchable with the recessed portion 113. The clasp 33 is latchable to the latching part 70.

The button 50 includes a pressing portion 51, two limiting portions 53, and a guiding block 55. The pressing portion 51 is engagable in the through hole 15. The limiting portions 53 are positioned on a same side of the pressing portion 51 and respectively extend from two ends of the pressing portion 51. The limiting portions 53 are configured for resisting the housing 10. The guiding block 55 is positioned on the pressing portion 51 between the limiting portions 53. The guiding block 55 defines a first inclined plane 551 configured for pushing the latching part 70.

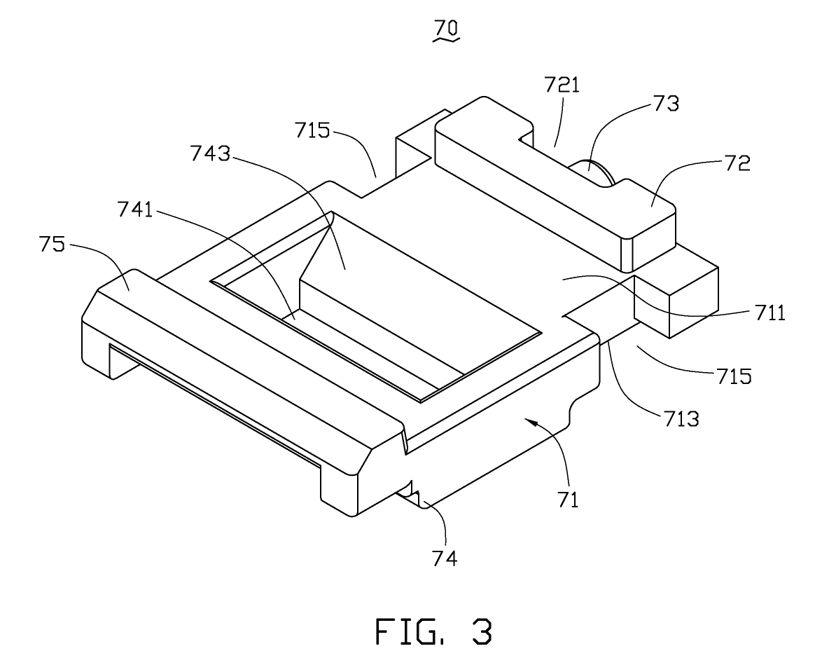

Referring to FIG. 3, the latching part 70 includes a main plate 71, a board 72, a post 73, a protrusion 74, and a latching part 75. The main plate 71 includes a first surface 711 and a second surface 713 opposite to the first surface 711. The main plate 71 defines two gaps 715 symmetrically formed in two edges thereof. The board 72 perpendicularly extends from a peripheral edge of the first surface 711. The board 72 is configured for resisting the baffle plate 16 to limit the sliding distance of the latching part 70. An end of the main plate 71 and the board 72 defines a chamber 721. The post 73 is positioned on a bottom of the chamber 721. The protrusion 74 is positioned on the second surface 713. The protrusion 74 defines a receiving portion 741 passing through the main plate 71. The receiving portion 741 has four inner walls (not labeled), one of the inner walls includes a second inclined plane 743 configured for resisting the first inclined plane 551 to move the button 50. The latching part 75 perpendicularly extends from a periphery edge of the second surface 713 opposite to the post 73. The latching part 75 is configured for resisting the supporting portions 14.

The resilient member 90 is a pressure spring coiled around the post 73 and configured for providing elastic force to the latching part 70.

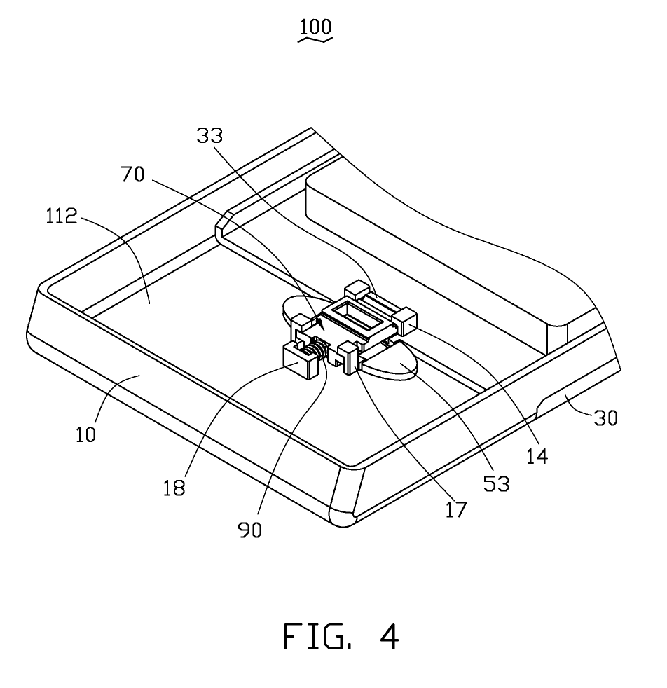

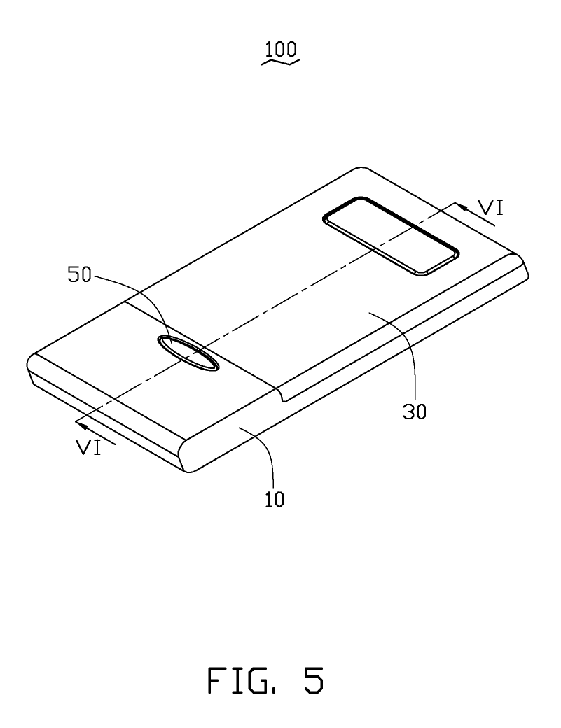

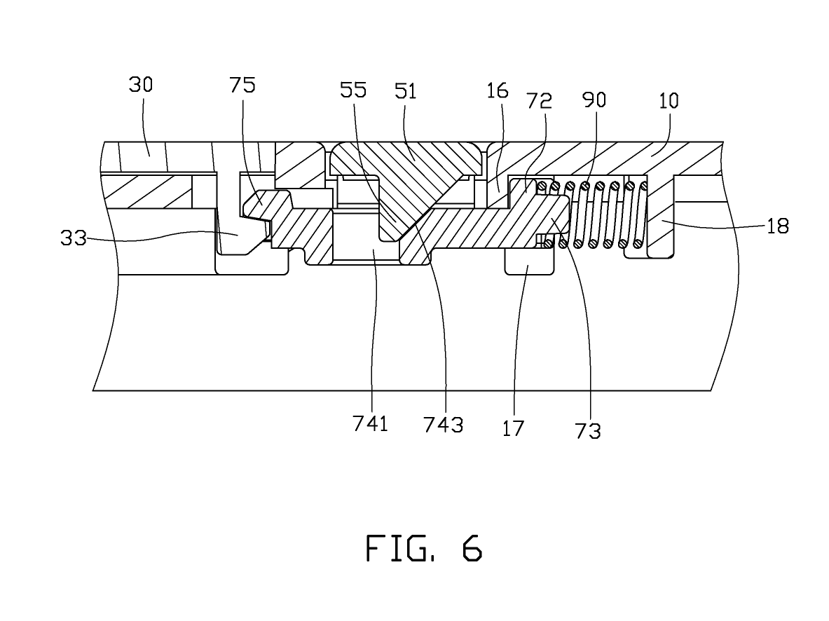

Referring to the drawings, FIG. 4 to FIG. 6, in assembly, the pressing portion is placed in the through hole 15. The limiting portions 53 resist the housing 10. The guiding block 55 passes through the receiving portion 741. The resisting posts 17 respectively pass through the gaps 715, the latching part 70 contacts with the main body 11. The latching part 70 is moved to the supporting portions 14 by an external force, thereby, the latching part 70 is received in the supporting portions 14. The board 72 resists the baffle plate 16. The resilient member 90 coils around the post 73 and resists the resisting plate 18. Meanwhile, the resilient member 90 generates an elastic force. Then, the external force is removed, the first inclined plane 551 resists the second inclined plane 743 by the elastic force of the resilient member 90. The sidewalls 32 of the battery cover 30 match with the recessed portion 113, and the clasp 33 extends through the latching hole 13 and latches to the latching part 75.

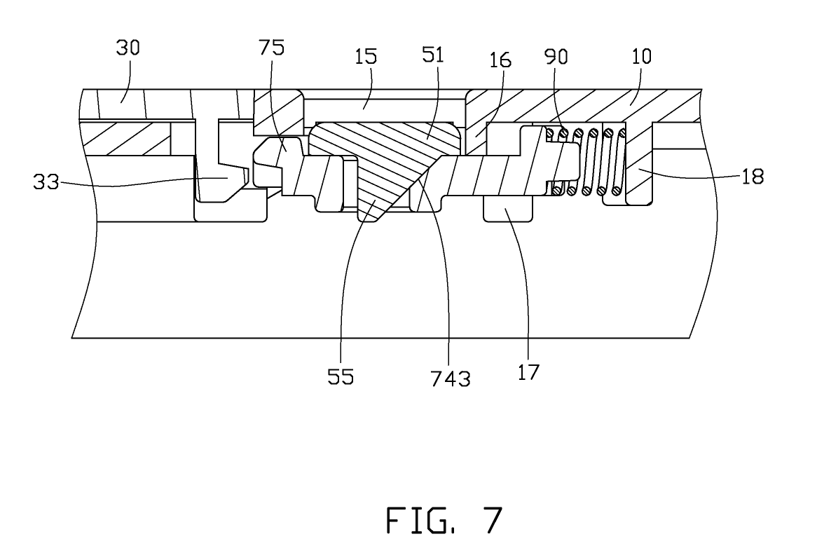

Referring to FIG. 7, when the battery cover 13 is to be detached from the housing 10, the pressing portion 15 is pressed by an external force, first inclined plane 551 resists the second inclined plane 743 and drives the latching part 70 move to the baffle plate 16. The resilient member 90 is compressed by the latching part 70 and the resisting plate 18, and is resiliently deformed. The latching part 75 is detached from the clasp 33, thereby, the battery cover 30 is disassembled from the housing 10.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latch mechanism used to releasably latching a battery cover to a housing, the battery cover latch mechanism, comprising:
a clasp positioned on the battery cover;
a button assembled on the housing;
a latching part slidably assembled on the housing, and resisting the button; and
a resilient member assembled on the latching part, and resisting the housing;
wherein the clasp latches to the latching part to assemble the battery cover on the housing, when the button is pressed, the latching part compresses the resilient member, and the latching part is detached from the clasp by the button.

2. The battery cover latch mechanism as claimed in claim 1, wherein the housing defines a latching hole and a through hole adjacent to the latching hole, and further comprises two supporting portions, one supporting portion symmetrically positioned at each side of the latching hole, and two resisting posts respectively aligning with the supporting portions, the latching part respectively resists the supporting portions and the resisting posts.

3. The battery cover latch mechanism as claimed in claim 2, wherein the latching part comprises a main plate and a board perpendicularly extending from the main plate, the housing further comprises a baffle plate positioned thereon and adjacent to the through hole, the board resists the baffle plate configured to limit the sliding distance of the latching part.

4. The battery cover latch mechanism as claimed in claim 3, wherein the button comprises a pressing portion and two limiting portions respectively extend from two ends of the pressing portion, the limiting portions resist the housing.

5. The battery cover latch mechanism as claimed in claim 4, wherein the button further comprises a guiding block positioned between the limiting portions, the guiding block resists the latching part.

6. The battery cover latch mechanism as claimed in claim 5, wherein the guiding block defines a first inclined plane thereon, the main plate defines a receiving portion therein, the receiving portion includes a second inclined plane resisting the first inclined plane.

7. The battery cover latch mechanism as claimed in claim 3, wherein the latching part further comprises a post positioned on an end of the main plate, the housing further comprises a resisting plate positioned thereon, the resilient member coils around the post, and resists the resisting plate.

8. The battery cover latch mechanism as claimed in claim 3, wherein the main plate defines two gaps corresponding to the resisting posts, the resisting posts respectively pass through the gaps.

9. A portable electronic device, comprising:
a housing;
a battery cover comprising a clasp positioned thereon;
a battery cover latch mechanism, comprising:
a button assembled on the housing;
a latching part slidably assembled on the housing; and resisting the button; and
a resilient member assembled on the latching part, and resisting the housing;
wherein the clasp latches to the latching part to assemble the battery cover on the housing, when the button is pressed, the latching part compresses the resilient member, and the latching part is detached from the clasp by the button.

10. The portable electronic device as claimed in claim 9, wherein the housing defines a latching hole and a through hole adjacent to the latching hole, and further comprises two supporting portions, one supporting portion symmetrically positioned at each side of the latching hole, and two resisting posts respectively aligning with the supporting portions, the latching part respectively resists the supporting portions and the resisting posts.

11. The portable electronic device as claimed in claim 10, wherein the latching part comprises a main plate and a board perpendicularly extending from the main plate, the housing further comprises a baffle plate positioned thereon and adjacent to the through hole, the board resists the baffle plate configured to limit the sliding distance of the latching part.

12. The portable electronic device as claimed in claim 11, wherein the button comprises a pressing portion and two limiting portions respectively extend from two ends of the pressing portion, the limiting portions resist the housing.

13. The portable electronic device as claimed in claim 12, wherein the button further comprises a guiding block positioned between the limiting portions, the guiding block resists the latching part.

14. The portable electronic device as claimed in claim 13, wherein the guiding block defines a first inclined plane thereon, the main plate defines a receiving portion therein, the receiving portion includes a second inclined plane resisting the first inclined plane.

15. The portable electronic device as claimed in claim 11, wherein the latching part further comprises a post positioned on an end of the main plate, the housing further comprises a resisting plate positioned thereon, the resilient member coils around the post, and resists the resisting plate.

16. The portable electronic device as claimed in claim 11, wherein the main plate defines two gaps corresponding to the resisting posts, the resisting posts respectively pass through the gaps.
